(19) United States
(12) Patent Application Publication
(10) Pub. No.: US 2007/0007890 A1
(43) Pub. Date: Jan. 11, 2007

(54) PLASMA DISPLAY PANEL

(75) Inventors: Hyun KIM, Suwon-si (KR); Kyoung-doo KANG, Suwon-si (KR); Se-Jong KIM, Suwon-si (KR); Yun-Hee KIM, Suwon-si (KR); Hyun SOH, Suwon-si (KR); Jin-Won HAN, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG SDI CO., LTD., Suwon-si (KR)

(21) Appl. No.: 11/428,055

(22) Filed: Jun. 30, 2006

(30) Foreign Application Priority Data
Jul. 7, 2005 (KR) 10-2005-0061161

(51) Int. Cl. H01J 1/62

(52) U.S. Cl. 313/509

(57) ABSTRACT

A plasma display panel includes a first substrate, a second substrate that faces the first substrate, and barrier ribs that define a plurality of discharge cells in a space between the first substrate and the second substrate. Common electrodes and scanning electrodes extend parallel to each other on the first substrate, and a dielectric layer covers the common and scanning electrodes. The dielectric layer includes groove shaped field concentration units arranged closer to the common electrodes than the scanning electrodes.

### CROSS-REFERENCE TO RELATED APPLICATION

This application claims priority to and the benefit of Korean Patent Application No. 10-2005-0061161, filed on Jul. 7, 2005, which is hereby incorporated by reference for all purposes as if fully set forth herein.

### BACKGROUND OF THE INVENTION

1. Field of the Invention

The present invention relates to a plasma display panel, and more particularly, to a plasma display panel having groove shaped field concentration units between discharge electrodes.

2. Discussion of the Background

Plasma display panels are becoming increasingly popular large flat display devices. Generally, a plasma display panel includes two substrates with a gas-filled discharge space therebetween, and a plurality of electrodes is formed on the substrates. The plasma display panel displays desired images using visible light emitted by exciting a phosphor material with ultraviolet rays generated from a gas discharge in the discharge space when applying a voltage to the electrodes.

A conventional plasma display panel typically includes a first panel and a second panel. The first panel includes a first substrate, common (X) and scanning (Y) electrodes, which both include a transparent electrode and a bus electrode, a first dielectric layer, and a protection film. The second panel includes a second substrate, address (A) electrodes, a second dielectric layer, barrier ribs, and a phosphor layer.

The first substrate and the second substrate are parallel to each other, and they are separated from each other such that they face each other. A space formed between the two substrates is partitioned by the barrier ribs to form unit discharge cells, in which discharge occurs. The X and Y electrodes cross with the A electrodes in each discharge cell. A panel capacitor is formed in each discharge cell by the dielectric layer and the electrodes included in the discharge cell.

When the distance between the X and Y electrodes decreases, a driving voltage applied to the electrodes may be reduced proportionally to the decreased distance. However, in this case, the plasma display panel's light emission efficiency may be reduced since a wide discharge space may not be utilized, making it difficult to display bright images. Also, when the distance between the X and Y electrodes decreases, the panel capacitance increases proportionally to the decreased distance.

On the other hand, when the distance between the X and Y electrodes, which generate a sustain discharge, increases, a wide discharge space may be utilized, thereby increasing light emission efficiency. However, driving voltage should be increased in proportion to the increased distance, resulting in increased power consumption.

### SUMMARY OF THE INVENTION

The present invention provides a plasma display panel including a biased field concentration unit structure that may prevent the loss of wall charges utilized in address discharge.

Additional features of the invention will be set forth in the description which follows, and in part will be apparent from the description, or may be learned by practice of the invention.

The present invention discloses a plasma display panel including a first substrate, a second substrate that faces the first substrate, and barrier ribs that define a plurality of discharge cells in a space between the first substrate and the second substrate. X electrodes and Y electrodes are arranged on the first substrate and covered by a first dielectric layer that has groove shaped field concentration units whose centers are closer to the X electrodes than the Y electrodes. A electrodes are arranged on the second substrate and extend substantially perpendicular to the X electrodes and the Y electrodes, and a second dielectric layer covers the A electrodes. A phosphor layer and a discharge gas are included in the discharge cells.

The present invention also discloses a plasma display panel including a first substrate, a second substrate that faces the first substrate, and barrier ribs that define a plurality of discharge cells in a space between the first substrate and the second substrate. First electrodes and second electrodes are arranged on the first substrate, and a dielectric layer covers the first electrodes and the second electrodes. The dielectric layer includes groove shaped field concentration units that are arranged between the first electrodes and the second electrodes, but are closer to the first electrodes than the second electrodes.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a partial perspective view of a plasma display panel having a biased field concentration unit according to an exemplary embodiment of the present invention.

FIG. 2 is a cross-sectional view taken along line II-II of FIG. 1.

FIG. 3 is a schematic drawing of field concentration units biased toward an X electrode as seen from a first substrate of the plasma display panel of FIG. 1.

FIG. 4 is a perspective view of field concentration units biased toward an X electrode in the plasma display panel of FIG. 1.

FIG. 5 is a block diagram of a driving device for driving the plasma display panel of FIG. 1.

FIG. 6 is a portion of waveforms of driving voltages applied to each of the electrodes of the plasma display panel of FIG. 1.

FIG. 7 is a cross-sectional view illustrating wall charges accumulated near electrodes at the end of a reset period when driving voltages having the waveforms of FIG. 6 are applied to the plasma display panel of FIG. 1.

FIG. 8 and FIG. 9 are schematic drawings of plasma display panels having different electrode structures according to exemplary embodiments of the present invention.

FIG. 10 is a cross-sectional view of a plasma display panel having a biased field concentration unit according to an exemplary embodiment of the present invention.

### DETAILED DESCRIPTION OF THE ILLUSTRATED EMBODIMENTS

The present invention will now be described more fully with reference to the accompanying drawings in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

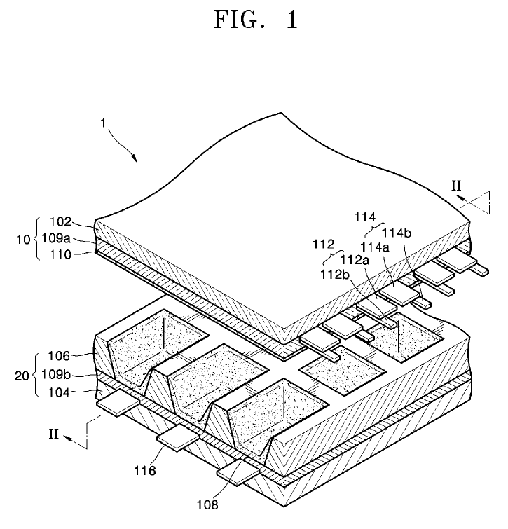

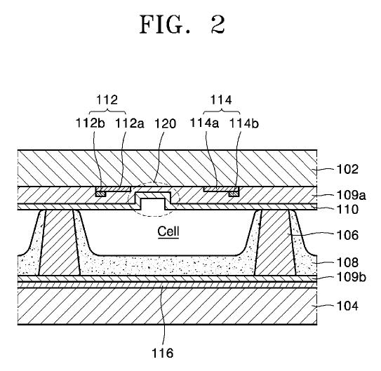

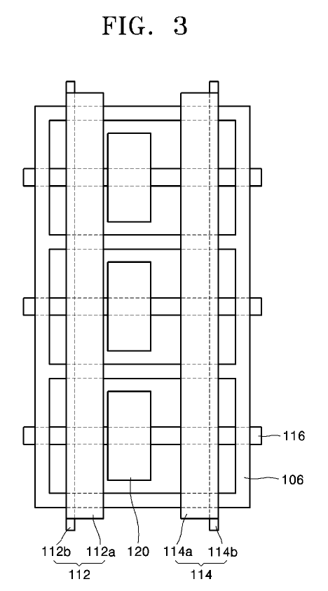

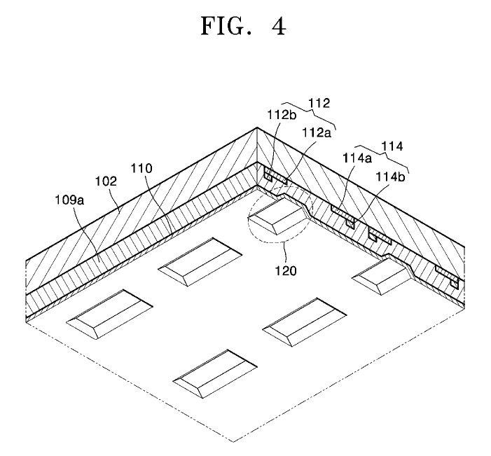

FIG. 1 is a partial perspective view of a plasma display panel 1 having a biased field concentration unit according to an exemplary embodiment of the present invention. FIG. 2 is a cross-sectional view taken along line II-II of FIG. 1. FIG. 3 is a schematic drawing of field concentration units 120 biased toward X electrodes 112 as seen from a first substrate 102 of the plasma display panel 1 of FIG. 1. FIG. 4 is a perspective view of the field concentration units 120 biased toward the X electrodes 112 of the plasma display panel 1 of FIG. 1.

Referring to FIG. 1, FIG. 2, FIG. 3 and FIG. 4, the plasma display panel 1 includes a first panel 10 and a second panel 20. The first panel 10 includes the first substrate 102, the X electrodes 112, Y electrodes 114, a first dielectric layer 109a, and a protection film 110. The X electrodes 112 include a transparent electrode 112a and a bus electrode 112b, and the Y electrodes 114 include a transparent electrode 114a and a bus electrode 114b. The second panel 20 includes a second substrate 104, A electrodes 116, a second dielectric layer 109b, barrier ribs 106, and a phosphor layer 108.

The first substrate 102 and the second substrate 104 are separated a predetermined distance from each other and face each other. The first substrate 102 may be substantially parallel to the second substrate 104. The barrier ribs 106 define a plurality of discharge cells in the space between the first substrate 102 and the second substrate 104.

The A electrodes 116 are arranged on the second substrate 104 substantially orthogonally to the X electrodes 112 and the Y electrodes 114. The X electrodes 112 and the Y electrodes 114 may cross with the A electrodes 116 in each discharge cell. The phosphor layer 108 is arranged on the barrier ribs 106 and the second dielectric layer 109b. A discharge gas is filled in the discharge cells.

The first dielectric layer 109a covers the X electrodes 112 and the Y electrodes 114. Groove shaped field concentration units 120 are formed on a surface of the first dielectric layer 109a facing the discharge cells. The protection film 110, which may be formed of magnesium oxide (MgO), is arranged on a surface of the first dielectric layer 109a facing the discharge cell to protect the first dielectric layer 109a. The second dielectric layer 109b covers the A electrodes 116.

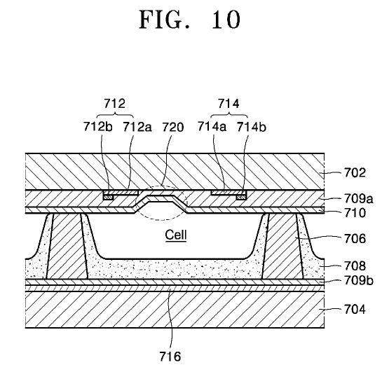

The X electrodes 112 and the Y electrodes 114 are arranged on the first substrate 102 and extend substantially parallel to each other. The cross-section of the field concentration unit 120, i.e., a cross-section perpendicular to the first substrate 102 and parallel to the A electrodes 116, may be substantially rectangular. However, as shown in FIG. 10, the cross-section of the field concentration unit 120 may alternatively be substantially trapezoidal.

The barrier ribs 106 define unit discharge cells, in which discharge takes place, in the space between the first substrate 102 and the second substrate 104. A discharge gas, at a pressure lower than atmospheric pressure (approximately less than 0.5 atm), is filled in the discharge cells. Plasma discharge is generated by the collision of discharge gas particles with charges, which are due to an electric field formed by a driving voltage applied to the electrodes located in each discharge cell, thereby generating vacuum ultraviolet rays.

The discharge gas may be a gas mixture containing one or more of Ne gas, He gas, and Ar gas mixed with Xe gas.

The barrier ribs 106 define the discharge cells to be basic units of an image, and they prevent cross-talk between adjacent discharge cells. According to an exemplary embodiment of the present invention, a horizontal cross-section of the discharge cells, i.e., a cross-section parallel to the first substrate 102 and the second substrate 104, may be polygonal, for example, rectangular, hexagonal, or octagonal; circular; or oval, and may vary according to the arrangement of the barrier ribs 106.

Electrons in the phosphor layer 108 are excited by absorbing discharge-generated vacuum ultraviolet rays, and photo luminescence occurs. That is, the excited electrons of the phosphor layer 108 generate visible light when they return to a stable state. The phosphor layer 108 may include red, green, blue phosphor layers such that the plasma display panel may display a color image. Three adjacent discharge cells having red, green, and blue phosphor layers, respectively, may constitute a unit pixel.

The red phosphor may be (Y,Gd)BO₃:Eu³⁺, etc., the green phosphor may be Zn₂SiO₄:Mn²⁺, etc., and the blue phosphor may be BaMgAl₁₀O₁₇:Eu²⁺, etc. In the drawings, the phosphor layer 108 is arranged on the second dielectric layer 109b and the barrier ribs 106 of the discharge cell. However, the phosphor layer may be arranged in various locations.

The first dielectric layer 109a insulates the X electrodes 112 and the Y electrodes 114, and it may be formed of a material having high electrical resistance and high light transmittance. Some of charges generated by discharge form wall charges on the protection film 110 near the first dielectric layer 109a because they are attracted to an electrical force caused by the polarity of the voltage applied to the X and Y electrodes 112 and 114.

The second dielectric layer 109b insulates the A electrodes 116, and it may be formed of a material having high electrical resistance. The protection film 110 protects the first dielectric layer 109a, and facilitates discharge by increasing the emission of secondary electrons.

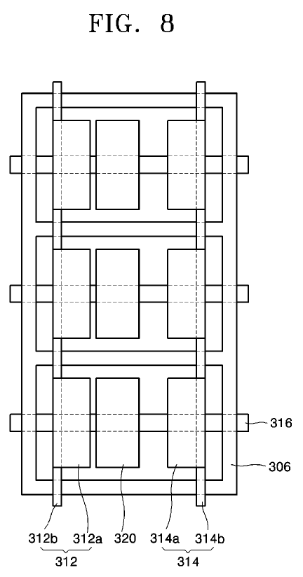

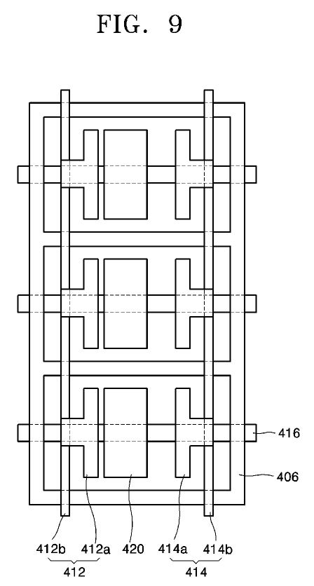

The X electrodes 112 and the Y electrodes 114 include the transparent electrodes 112a and 114a and the bus electrodes 112b and 114b, respectively. In the present embodiment, the bus electrodes 112b and 114b have a single body structure extending across the first panel 10. The transparent electrodes 112a and 114a have a single body structure extending across the first panel 10 on the bus electrodes 112b and 114b, respectively. However, as shown in FIG. 8 and FIG. 9, the transparent electrodes 112a and 114a may have a segmented structure corresponding to each discharge cell.

The transparent electrodes 112a and 114a may be formed of a transparent material, such as indium tin oxide (ITO), to transmit visible light emitted from the discharge cells. The transparent electrodes 112a and 114a may have high electrical resistance. Therefore, their electrical conductivity may be increased by including the bus electrodes 112b and 114b, which may be formed of a metal having high electrical conductivity.

The field concentration unit 120 may be formed by, for example, etching the first dielectric layer 109a. The field concentration unit 120 reduces a discharge path between the X electrodes 112 and the Y electrodes 114. The field concentration effects of the central portion of the groove shaped space of the field concentration unit 120, together with the reduced discharge path, increase the density of electrons (negative charges) and ions (positive charges) in the field concentration unit 120, thereby facilitating discharge between the X electrodes 112 and the Y electrodes 114. Also, when the field concentration units 120 are included, the discharge space may be increased by increasing the distance between the X electrodes 112 and the Y electrodes 114, thus increasing the light emission efficiency. Furthermore, the transmittance of visible light emitted from the discharge cells through the first panel 10 may be increased in proportion to the amount of etched first dielectric layer 109a.

The field concentration units 120 may be arranged to correspond to the discharge cells, and in this case, they are separated by portions of the first dielectric layer 109a corresponding to the barrier ribs 106. However, the field concentration units 120 may have various arrangements. According to an exemplary embodiment of the present invention, the field concentration units 120 may be connected over a plurality of the discharge cells.

In FIG. 2, the cross-section of the field concentration unit 120, i.e., a cross-section perpendicular to the first substrate and parallel to the A electrodes 116, is substantially rectangular. As FIG. 10 shows, the cross-section of the field concentration unit 120 may be substantially trapezoidal. Further, the cross-section of the field concentration unit 120 may have various shapes.

The field concentration unit 120 is arranged closer to the X electrodes 112 than the Y electrodes 114. When the field concentration unit 120 is arranged equidistant from the X electrode 112 and the Y electrode 114, some wall charges that should accumulate near the Y electrode 114 to accurately generate an address discharge may migrate to the field concentration unit 120. Accordingly, to generate a stable address discharge, a high scan pulse voltage should be applied to the Y electrode 114.

In particular, wall charges may migrate when the field concentration unit 120 is arranged close to the Y electrode 114. Accordingly, according to an exemplary embodiment of the present invention, the field concentration unit 120 is arranged further away from the Y electrode 114 than the X electrode 112. That is, the center of the field concentration unit 120 is arranged closer to the X electrode 112 than the Y electrode 114.

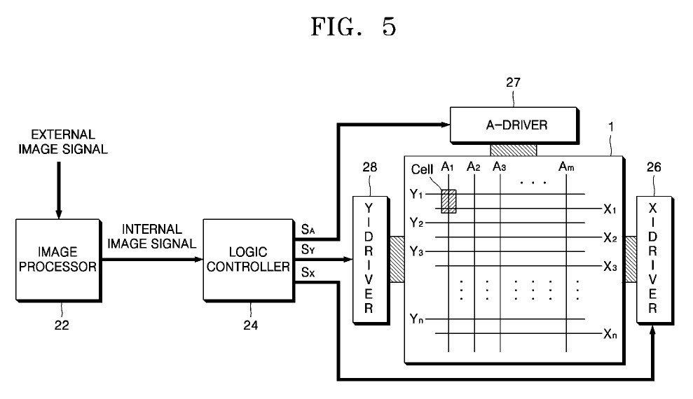

FIG. 5 is a block diagram of a driving device that may be used to drive the plasma display panel 1 of FIG. 1.

Referring to FIG. 5, the plasma display panel driving device includes an image processor 22, a logic controller 24, an X electrode driver 26, a Y electrode driver 28, and an A electrode driver 27. In FIG. 5, the plasma display panel 1 includes alternately arranged X electrodes X₁ through Xₙ and Y electrodes Y₁ through Yₙ, and A electrodes A₁ through Aₘ are arranged substantially perpendicular to the X and Y electrodes.

The image processor 22 transforms an external image signal, such as a video signal, a TV signal, etc., into a digital signal, generates an internal image signal by processing the transformed digital signal, and transmits the internal image signal to the logic controller 24.

The logic controller 24 generates an X electrode driver control signal S_{X}, a Y electrode driver control signal S_{Y}, and an A electrode driver control signal S_{A} by processing the internal image signal received from the image processor 22 using gamma correction.

The X electrode driver 26 receives the X electrode driver control signal S_{X} from the logic controller 24 and applies a driving voltage to the X electrodes X₁ through Xₙ. The Y electrode driver 28 receives the Y electrode driver control signal S_{Y} from the logic controller 24 and applies a driving voltage to the Y electrodes Y₁ through Yₙ. The A electrode driver 27 receives the A electrode driver control signal S_{A} from the logic controller 24 and applies a driving voltage to the A electrodes A₁ through Aₘ.

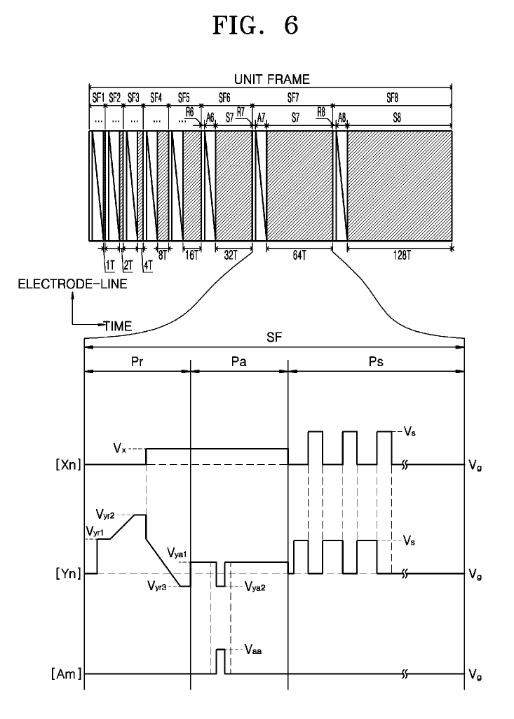

Visible light is emitted in the discharge space of the discharge cell due to the driving voltages applied to the X, Y and A electrodes X₁ through Xₙ, Y₁ through Yₙ, and A₁ through Aₘ to display an image corresponding to the external image signal. The driving voltages applied to the X, Y and A electrodes X₁ through Xₙ, Y₁ through Yₙ and A₁ through Aₘ of the plasma display panel 1 will be described below with reference to FIG. 6.

FIG. 6 is a portion of waveforms of the driving voltages that may be applied to the X, Y and A electrodes Xₙ, Yₙ, and Aₘ of the plasma display panel of FIG. 1.

Referring to FIG. 6, in an address display separation (ADS) method, a driving voltage is applied the X, Y and A electrodes Xₙ, Yₙ, and Aₘ to drive the plasma display panel. In the ADS method, a unit frame for displaying an image is divided into a plurality of sub-fields (SFs), which are further divided into a reset period Pr, an address period Pa, and a sustain discharge period Ps. Afterward, driving voltages having a period, as shown in FIG. 6, for example, may be applied to each of the X, Y and A electrodes Xₙ, Yₙ, and Aₘ.

In the reset period Pr, to generate a reset discharge which initializes all discharge cells, a step waveform voltage that increases from a ground voltage V_{g} to a voltage Vₓ is applied to the X electrode Xₙ, a ramp type reset pulse voltage that increases at a constant rate from V_{yr1} to V_{yr2} and then decreases at a constant rate from V_{yr1} to V_{yr3} is applied to the Y electrode Yₙ, and the ground voltage V_{g} is applied to the A electrode Aₘ.

In the address period Pa, to generate an address discharge for selecting discharge cells, the voltage Vₓ is applied to the X electrode Xₙ, a scan pulse voltage that is maintained at V_{ya1} and decreased from V_{ya1} to V_{ya2} and increased from V_{ya2} back to V_{ya1} in a stepwise fashion is applied to the Y electrode Yₙ, and an address pulse voltage that is maintained at V_{g} and increased from V_{g} to Vₐₐ and decreased from Vₐₐ back to V_{g} in a stepwise fashion is applied to the A electrode Aₘ.

In the sustain discharge period Ps, to generate a sustain discharge for displaying an image corresponding to an external image signal, a pulse voltage alternating between the ground voltage V_{g} and sustain voltage Vₛ is applied to the X electrode Xₙ and the Y electrode Yₙ, and the ground voltage V_{g} is applied to the A electrode Aₘ.

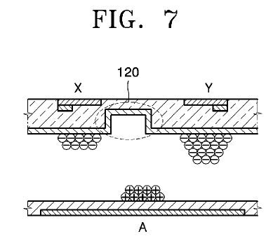

FIG. 7 is a cross-sectional view illustrating wall charges accumulated near X, Y and A electrodes X, Y and A at the end of the reset period Pr when driving voltages having the waveforms of FIG. 6 are applied to the plasma display panel of FIG. 1.

Referring to FIG. 7, in the reset period Pr, a weak reset discharge is generated among the electrodes by applying a step waveform voltage that increases from V_{g} to Vₓ to the X electrode, applying a ramp type reset pulse voltage that increases at a constant rate from V_{yr1} to V_{yr2} and decreases at a constant rate from V_{yr1} to V_{yr3} to the Y electrode, and applying a ground voltage V_{g} to the A electrode.

Some charges generated by the reset discharge are induced by an electric field resulting from the voltages applied to the X, Y and A electrodes, and, as FIG. 7 shows, form wall charges by accumulating near the electrodes where a voltage with an opposite polarity is applied. In the reset period Pr, a ramp type reset pulse voltage, which is a strong positive polarity (+) voltage, is applied to the Y electrode, a step waveform voltage, which is a positive polarity (+) voltage, is applied to the X electrode, and a ground voltage (having a negative polarity relative to the X and Y electrodes) is applied to the A electrode. Referring to FIG. 7, many negative polarity (−) wall charges may accumulate near the Y electrode, many negative polarity (−) wall charges may accumulate near the X electrode, and many positive polarity (+) wall charges may accumulate near the A electrode.

At the end of the reset period Pr, all the discharge cells are initialized to have substantially the same wall charge state.

The positive polarity (+) wall charges accumulated near the A electrode during the reset period Pr form a positive polarity (+) wall voltage, which produces an electric field in a discharge space together with the positive polarity (+) address pulse voltage applied to the A electrode. The wall voltage generated by the positive polarity (+) wall charges accumulated near the A electrode during the reset period Pr facilitates the process of selecting discharge cells for emitting light in the address period Pa since the wall voltage may reduce the magnitude of the address pulse voltage that must be applied to the A electrode to generate an effective address discharge.

Also, the negative polarity (−) wall charges accumulated near the Y electrode during the reset period Pr form a negative polarity (−) wall voltage, which produces an electric field in the discharge space together with the negative polarity (−) scan pulse voltage applied to the Y electrode in the address period Pa. The wall voltage generated by the negative polarity (−) wall charges accumulated near the Y electrode during the reset period Pr facilitate the process of selecting discharge cells for emitting light in the address period Pa since the wall voltage may reduce the magnitude of the scan pulse voltage that must be applied to the Y electrode to generate an effective address discharge.

When the field concentration unit 120 is arranged equidistant from the X electrode 112 and the Y electrode 114, some of the wall charges that should accumulate near the Y electrode 114 after completion of the reset period Pr may migrate to the field concentration unit 120. In this case, the magnitude of a scan pulse voltage to be applied to the Y electrode 114 should be increased according to the reduction in the wall voltage. Accordingly, to proceed through the address period Pa properly, the absolute value of the scan pulse voltage to be applied to the Y electrode 114 should be increased.

However, by forming the field concentration unit 120 closer to the X electrode 112 than the Y electrode 114, the field concentration unit 120 does not reduce the wall charges available for generating an address discharge. Accordingly, the field concentration unit 120 may reduce the magnitude of the scan pulse voltage to be applied to the Y electrode 114 in the address period Pa because it does not cause migration of the negative polarity (−) wall charges accumulated near the Y electrode Yₙ.

FIG. 8 and FIG. 9 are plan views of plasma display panels having different electrode structures according to exemplary embodiments of the present invention.

The plasma display panels of FIG. 8 and FIG. 9 have different transparent electrode structures than the plasma display panel 1 of FIG. 1. Similar reference numerals in FIG. 8 and FIG. 9 are used for like elements performing the same functions as those in FIG. 1, and the detailed descriptions thereof will not be repeated, except for the structure of the transparent electrodes 312a, 314a, 412a, and 414a, which will be described below.

Referring to FIG. 8 and FIG. 9, X electrodes 312 and 412 and Y electrodes 314 and 414 include bus electrodes 312b, 412b, 314b, and 414b and transparent electrodes 312a, 412a, 314a, and 414a, respectively. The bus electrodes 312b, 314b, 412b, and 414b have a single body structure extending across the plasma display panels. The transparent electrodes 312a, 314a, 412a, and 414a are arranged on portions of the bus electrodes 312b, 314b, 412b, and 414b corresponding to the discharge cells. The transparent electrodes 312a, 314a, 412a, and 414a have a segmented structure in which they are separated from each other by portions of the bus electrodes 312b, 314b, 412b, and 414b corresponding to the barrier ribs 306 and 406, respectively.

The transparent electrodes 312a and 314a of FIG. 8 have a rectangular shape when viewed from the first substrate, and the transparent electrodes 412a and 414a of FIG. 9 have a T shape when viewed from the first substrate.

In the present embodiments, an area of the transparent electrodes through which visible light generated by the discharge cells must transmit is reduced. Accordingly, the transmittance of visible light may be increased in proportion to the reduction in the area of the transparent electrodes.

FIG. 10 is a cross-sectional view of a plasma display panel having a field concentration unit 720 according to another exemplary embodiment of the present invention. The field concentration unit 720 has a different shape than the field concentration unit 120 of the plasma display panel 1 of FIG. 1.

Referring to FIG. 10, similar reference numerals are used for like elements performing the same functions as those in FIG. 1, and the detailed descriptions thereof will not be repeated, except for the shape of the field concentration unit 720, which will be described below.

In the plasma display panel of FIG. 10, the cross-section of the field concentration unit 720, i.e., a cross-section perpendicular to a first substrate 702 and parallel to an A electrode 716, is substantially trapezoidal. The field concentration unit 720 may be formed by, for example, etching a first dielectric layer 709a. The field concentration unit 720 is closer to the X electrode 712 than the Y electrode 714 to prevent the migration of wall charges so that an address discharge may be appropriately generated.

In FIG. 2, the cross-section of the field concentration unit 120, i.e., the cross-section perpendicular to the first substrate 102 and parallel to the A electrode 116, is substantially rectangular. In FIG. 10, the shape of a cross-section of the field concentration unit 720, i.e., the cross-section perpendicular to the first substrate 702 and parallel to the A electrode 716, is substantially trapezoidal. However, the cross-section of the field concentration units may have various shapes.

In a plasma display panel according to an exemplary embodiment of the present invention, the loss of wall charge required for generating an address discharge may be prevented by arranging a field concentration unit closer to the X electrode than the Y electrode.

Also, the plasma display panel according to the present invention may obtain a stable address voltage, thereby reducing the address driving voltage.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel, comprising:
a first substrate;
a second substrate that faces the first substrate;
barrier ribs that define a plurality of discharge cells in a space between the first substrate and the second substrate;
common electrodes and scanning electrodes arranged on the first substrate;
a first dielectric layer that covers the common electrodes and the scanning electrodes, the first dielectric layer comprising groove shaped field concentration units;
address electrodes arranged on the second substrate and extending substantially perpendicular to the common electrodes and the scanning electrodes;
a second dielectric layer covering the address electrodes;
a phosphor layer arranged in the discharge cells; and
a discharge gas in the discharge cells,
wherein centers of the field concentration units are closer to the common electrodes than the scanning electrodes.

2. The plasma display panel of claim 1, wherein the field concentration units are arranged corresponding to the discharge cells and separated from each other by portions of the first dielectric layer corresponding to the barrier ribs.

3. The plasma display panel of claim 1, wherein both the common electrodes and the scanning electrodes comprise:
a bus electrode comprising a single body structure extending across the plasma display panel; and
a transparent electrode comprising a segmented structure such that segments of the transparent electrode corresponding to the discharge cells are separated from each other by portions of the bus electrode corresponding to the barrier ribs.

4. The plasma display panel of claim 3, wherein the segments of the transparent electrode are rectangular.

5. The plasma display panel of claim 3, wherein the segments of the transparent electrode are T-shaped.

6. The plasma display panel of claim 1, wherein both the common electrodes and the scanning electrodes comprise:
a bus electrode comprising a single body structure extending across the plasma display panel; and
a transparent electrode comprising a single body structure extending across the plasma display panel.

7. The plasma display panel of claim 1, wherein a cross-section of the field concentration units cut perpendicular to the first substrate and parallel to the address electrodes is substantially rectangular.

8. The plasma display panel of claim 1, wherein a cross-section of the field concentration units cut perpendicular to the first substrate and parallel to the address electrodes is substantially trapezoidal.

9. The plasma display panel of claim 1, further comprising a protection film protecting the first dielectric layer.

10. The plasma display panel of claim 1, wherein the phosphor layer is arranged on the second substrate and the barrier ribs.

11. A plasma display panel, comprising:
a first substrate;
a second substrate that faces the first substrate;
barrier ribs that define a plurality of discharge cells in a space between the first substrate and the second substrate;
first electrodes and second electrodes arranged on the first substrate; and
a dielectric layer that covers the first electrodes and the second electrodes, the dielectric layer comprising groove shaped field concentration units arranged between the first electrodes and the second electrodes,
wherein the field concentration units are closer to the first electrodes than the second electrodes.

12. The plasma display panel of claim 11, wherein the field concentration units are arranged corresponding to the discharge cells and separated from each other by portions of the dielectric layer corresponding to the barrier ribs.

13. The plasma display panel of claim 11, wherein both the first electrodes and the second electrodes comprise:
a bus electrode comprising a single body structure extending across the plasma display panel; and
a transparent electrode comprising a segmented structure such that segments of the transparent electrode corresponding to the discharge cells are separated from each other by portions of the bus electrode corresponding to the barrier ribs.

14. The plasma display panel of claim 13, wherein the segments of the transparent electrode are rectangular.

15. The plasma display panel of claim 13, wherein the segments of the transparent electrode are T-shaped.

16. The plasma display panel of claim 11, wherein both the first electrodes and the second electrodes comprise:
a bus electrode comprising a single body structure extending across the plasma display panel; and
a transparent electrode comprising a single body structure extending across the plasma display panel.

17. The plasma display panel of claim 11, wherein a cross-section of the field concentration units cut perpendicular to the first substrate is substantially rectangular.

18. The plasma display panel of claim 11, wherein a cross-section of the field concentration units cut perpendicular to the first substrate is substantially trapezoidal.

19. The plasma display panel of claim 11, further comprising a protection film protecting the dielectric layer.

20. The plasma display panel of claim 11, wherein centers of the field concentration units are closer to the first electrodes than the second electrodes.
